(19) United States
(12) Patent Application Publication
(10) Pub. No.: US 2017/0032043 A1
(43) Pub. Date: Feb. 2, 2017

(54) SYSTEM AND METHOD FOR CONTENT IMAGE ASSOCIATION AND NETWORK-CONSTRAINED CONTENT RETRIEVAL

(71) Applicant: MEEMIM INC., Toronto (CA)

(72) Inventor: Alexandre PESTOV, Toronto (CA)

(21) Appl. No.: 14/934,936

(22) Filed: Nov. 6, 2015

Related U.S. Application Data
(63) Continuation-in-part of application No. 14/810,052, filed on Jul. 27, 2015.
(60) Provisional application No. 62/251,435, filed on Nov. 5, 2015.

(51) Int. Cl. G06F 17/30

(52) U.S. Cl. CPC G06F 17/30867; G06F 17/3028; G06F 17/30268

(57) ABSTRACT

Described herein are embodiments of a content management system for private knowledge repositories. The system comprises a content management module for carrying out: a method of content creation to create a unit of content; a method of content association to associate an image with the unit of content; a search function to retrieve search results including the unit of content and the associated image; and a search function to retrieve search results constrained to a user's network in a private social network. The search functions thus provide social network-defined image-based content retrieval.

### TECHNICAL FIELD

The following relates generally to systems and methods for content management and more specifically to content image association and network-constrained content searching.

### BACKGROUND

The proliferation of digital technology has led to widespread use of structured and unstructured digital knowledge repositories as knowledge formalization tools within companies and communities, including private and enterprise knowledge repositories (collectively referred to as “private knowledge repositories”), such as enterprise intranets, internal social networks and private wiki sites.

A typical digital knowledge repository allows for structured storage of information in the form of computer files, databases or distributed systems that contain text, graphics, and other data. To organize the information, users of the system create textually-named units of organization corresponding to projects, collaborative groups, articles, notes, posts, etc. (collectively referred to herein as “units of content”). Information may be linked to the units of content in a lower-level structure such as a ‘conversational’ structure that allows multiple users to add comments or new information to the units of content in a collaborative back and forth process.

In private knowledge repositories, stored information may merely have relevance to the user that added the information to the repository, or may have relevance to particular communities of users within an organization (e.g. a group, business unit, department, enterprise, project, etc.). For example, stored information may be of relevance to training for a particular role in a project team, or to administrative policies for a particular business unit.

To be useful, knowledge repositories must contain volumes of information. However, searching for content in extensive knowledge repositories consequently returns many results mainly composed of text that has to be reviewed and sorted manually by the user.

Besides direct navigation of the repository and review of its textual structure and content, retrieval of information from a knowledge repository is typically done through a search function. Currently, most search functions provide search results as text which has to be reviewed manually by users.

Modern search functions take a partial or whole query text from the user (i.e. a keyword or text phrase query), search the knowledge repository utilizing a search engine for content which contains the text or has a name or other sort of label relating to it, and then present an organized list of results which may also contain additional semantic information or previews of the results.

Some modern search engines designed or adopted for use in private knowledge repositories attempt to use predictive results sorting based on a variety of factors. However, in order to avoid filtering out the information that a user requests, information retrieval methods often provide statistically similar results to the desired content that the user is looking for (i.e. to the search query) to ensure that the desired content is somewhere within the results.

Even with the most advanced modern search engines, knowledge repositories with large amounts of data may often return large sets of results, requiring users to perform a time-consuming manual review of the search results in order to locate their desired content.

Other methods of search exist, such as relying on human indexing of the information or meta search of search algorithms to provide results.

### SUMMARY

These and other aspects are contemplated and described herein. It will be appreciated that the foregoing summary sets out representative aspects of systems and methods, to assist skilled readers in understanding the following detailed description.

### DESCRIPTION OF THE DRAWINGS

A greater understanding of the embodiments will be had with reference to the Figures, in which:

FIG. 1 shows a content management system;

FIG. 2 shows a flowchart of a method of content creation;

FIG. 3 shows a flowchart of a method of content image association;

FIG. 4 shows a schematic diagram of the method of content image association of the present invention;

FIG. 5 shows a flowchart of a search function; and

FIG. 6 shows a schematic diagram of the search result of the present invention; and

FIG. 7 shows a flowchart of a network-constrained search function.

FIG. 8 shows a possible user interface screen of the content management system comprising a home screen;

FIG. 9 shows a possible user interface screen of the content management system comprising ‘boards’ of content selected by a user;

FIG. 10 shows a possible user interface screen of the content management system comprising a particular ‘board’ of content;

FIG. 11 shows a possible user interface screen of the content management system comprising a graphic representation of the user's network; and

FIG. 12 shows a possible user interface screen of the content management system comprising a possible search result;

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

Content is being created at incredible rates. In the particular field of knowledge management, it is becoming increasingly difficult to maintain the balance between depth of knowledge and convenient access to that knowledge. In enterprise environments, in particular, time spent searching for knowledge can be considered a productivity and therefore monetary loss.

Studies have shown that workers spend a significant part of their day searching for information. The information is generally stored as textual content searchable by text. Typically, content is stored in a knowledge management system and made searchable through text based search. Results are generally provided as a list of textual links to the content. A particular searcher typically must review each link, and in cases each content item, to evaluate whether it is relevant to the search. Often, it can take significant time to locate the desired content item.

Much of the focus on content retrieval has been in the area of improving the automatic searching of databases and machine-based, algorithmic retrieval of relevant results. Conversely, the following is directed to improving the subsequent manual human review of those search results. The following provides a content management system which benefits from the natural tendency of humans to recognize and process images faster than they can for text. Accelerated information access has a direct positive impact on employee productivity and engagement. Embodiments described herein provide an improved content management system for private knowledge repositories combining, on the one hand, image association with uploaded content, and on the other a social network constrained search function.

On the one hand, the described content management system assigns units of content uploaded and stored in a private knowledge repository with semantically related images, and presents those assigned images to the user during navigation and search of the knowledge repository. This approach leverages the human user's associative memory and capability for fast image processing to enables\ them to quickly find the information most relevant to them during navigation or within a set of search results. If the user querying for information was the one who entered it into the database as a unit of content, then that person will have associated an image to the information and can quickly find the information by visually looking through the search results for that image, which will tend to naturally stand out to that user. If the user is querying for information that he/she did not personally enter, or if he/she fails to recall the associated image from memory, the semantic relation between images and content provides visual cues, directing the user to the correct information more quickly that would be the case with text.

Further, the described content management system implements a network-constrained search function. As described above, in private knowledge repositories, units of content may be relevant to particular users, or to groups of users. The network-constrained search function limits search results based on the user's relationship with content creators. This reduces the scope of searches to a narrower result set that is likely to be a more relevant result set.

The combination of the network-constrained search, supplemented by the visual cues realized through image association, provides a content management system that may greatly speed up navigation and manual review of a result set.

Businesses that maintain large amounts of content or knowledge are prime candidates for the presently disclosed system. Health care providers, for instance, could benefit from the use of the content management system by using pictures of ailments as the assigned images to help medical practitioners search through results in medical databases to hone in on treatment or diagnostic information. Businesses that deal with large numbers of products, equipment, or other materials could benefit by using the pictures of these objects as the assigned images that are to be visually searched through to hone in on content.

Further, the content management system encourages users to store often-needed information. Use of the content management system within a company, will mean that over time employees can crowd-source a knowledge repository that encapsulates the knowledge of departments, projects, and jobs. Such a repository will allow for quick training of new staff, with managers of departments using the content management system to set up training material for employees under their department. Business users will appreciate the encapsulation of useful, non-formalized knowledge relating to their business and its operations, as this will protect the company from losing critical information when employees who have amassed a large personal knowledge base leave the company.

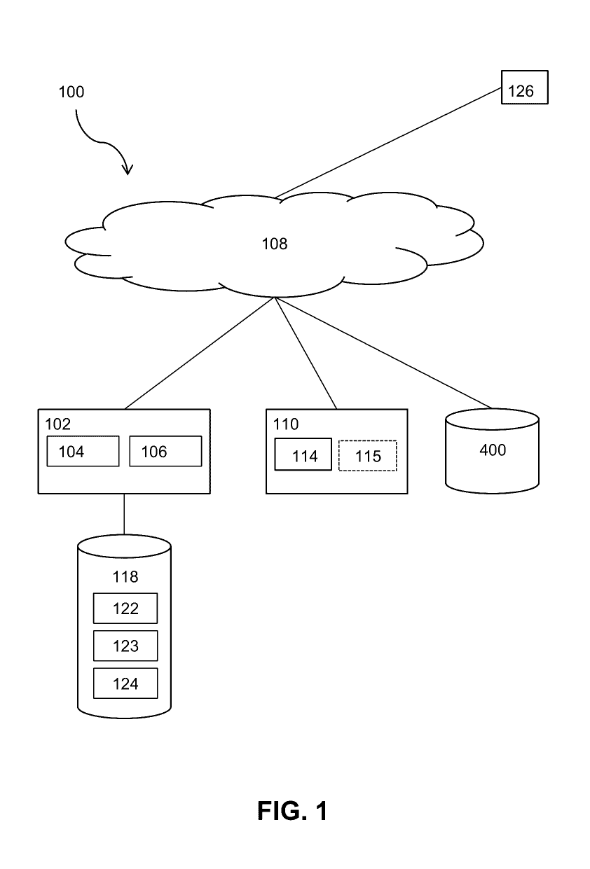

Referring now to FIG. 1, a content management system 100 is shown. The content management system 100 comprises a content management module 102 and a private knowledge repository 118. In certain embodiments, the content management system 100 may further comprise or by linked to an image bank 400. The content management module 102 is also linkable by network 108 to at least one user device 110. The components of the system 100 may be communicatively linked over a wired or wireless communication network 108.

The content management module 102 comprises or is communicatively linked to the private knowledge repository 118 for storing units of content 124 and associated metadata 122. The private knowledge repository may further store images associated with the units of content pursuant to the method 160 (as described below), and may store user information 123 for authenticating users to the system. The content management module may be embodied as a hardware server or a virtualized server.

The content management module stores to the private knowledge repository a variety of types of information using industry standard database technology. As used herein, the term “knowledge repository” suggests a memory in the form of volatile memory, disc drive, or non-volatile memory including flash memory, on-board or captive digital memory, removable digital memory such as SD cards or portable disc drives, on-line storage systems such as cloud technology, or any of the memory media previously described to store and maintain a plurality of units of content and to be accessed for retrieval by a user to search for a specific unit of content.

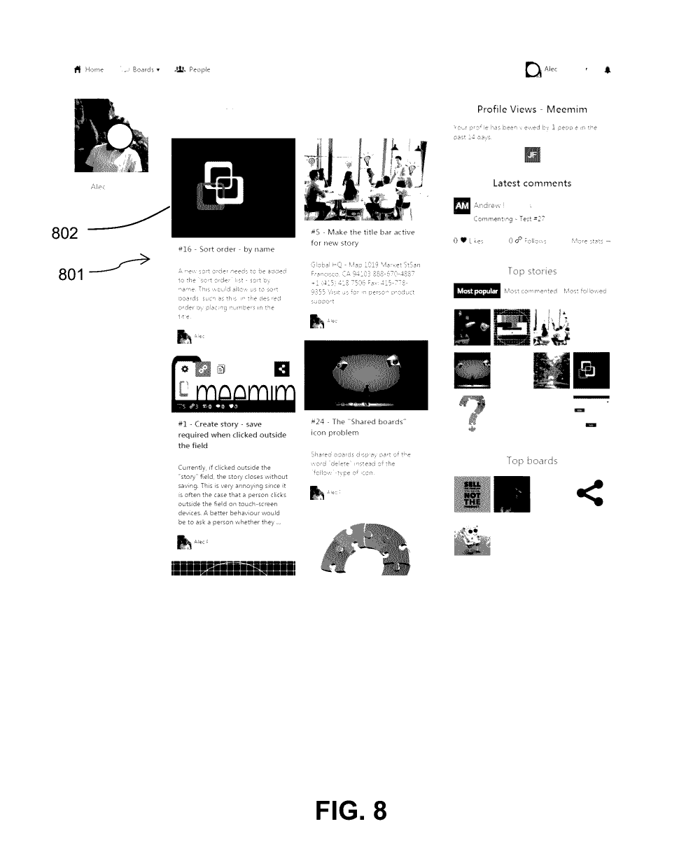

The content management module comprises instructions and processing resources 106 for receiving user input from a user device 110, and providing services for carrying out the steps of the method of content creation 150, the method of image association 160, and the search functions 180, 190 described below. To this end, the content management module may host an associated user interface 104 accessible over the network 108 for accessing these services by user devices 110. The user interface may display user interface screens and functionality as described in relation to FIGS. 8 to 12 for navigating through the units of content stored in the private knowledge repositories, and for carrying out searches thereof. The content management module may be communicatively linked to an external knowledge repository 126, such as a third-party social network. The content management module may ingest information from the external knowledge repository through an API.

The user device 110 is a computing device for accessing the services of the content management module. A user adding content to the repository 118 according to the method 150 is referred to for simplicity as the “creator” of the unit of content, whether or not they actually composed the content. The user device may comprise an input device 114, such as a touchscreen or a computer peripheral, for facilitating data entry to the user device 110 for communication to the content management module. The user device 110 may comprise a client-side application 115 to interact with the content management module 102 over the network to access the services. A client-side application may provide additional functionality to improve the user experience, including the provision of context menus in an operating system for invoking the services of the content management module 102 (such as for uploading documents), as well as integrating with resources stored at the user device, such as locally stored images.

The image bank 400 stores or makes accessible to the content management module a plurality of images, such as images uploaded from a storage device (such as a digital camera) for use with the system, or uploaded to online sources (such as Google Images™ or Dropbox™). The term “image bank” in the present invention refers to all available sources of images for the system to select and assign image(s) to the units of content pursuant to the method of content image association 160.

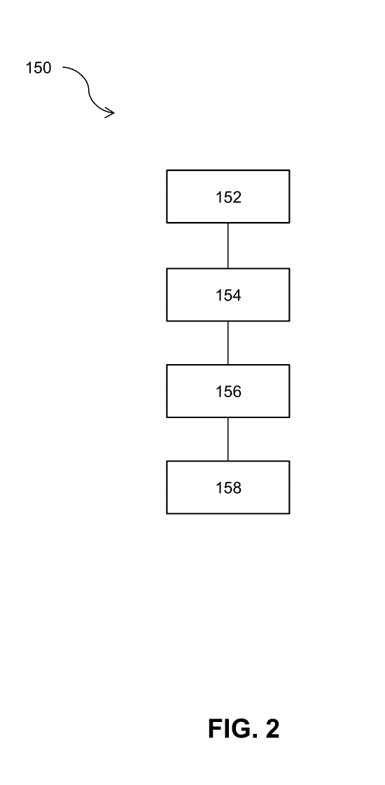

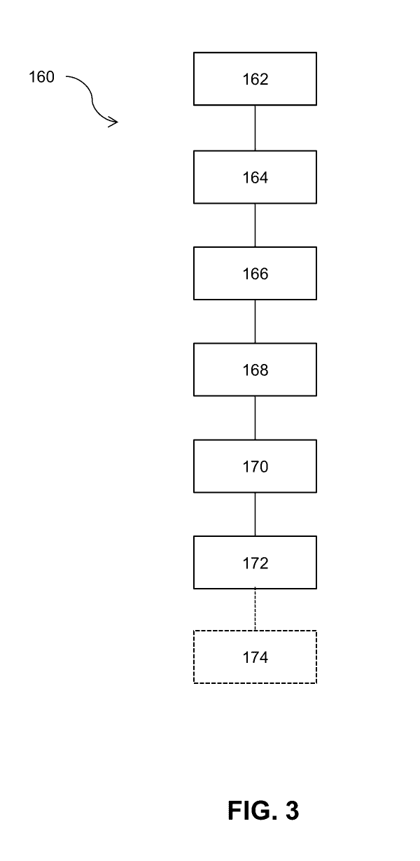

Referring now to FIG. 2, a method of content creation 150 to be carried out by the content management module 102 of the system 100 is shown. At block 152, a unit of content (such as a note or an article) is created or edited by a creator, and is stored in the knowledge repository 118. A unit of content, as further described above, may be a written work created by a computer program and published in an electronic form for a variety of purposes such as for publishing news, research results, reports, academic analysis or debate. It may contain photographs, accounts, statistics, graphs, recollections, interviews, polls, debates on the topic, etc. At block 154, the method of content image association 160 (shown in FIG. 3) is triggered by the creation or editing of the unit of content. At block 156, one image or a plurality of images is assigned to the unit of content. At block 158, the unit of content is saved in the knowledge repository.

Referring now to FIG. 3, a method of content image association 160 is shown. As will be appreciated from the following, the steps of method 160 can be carried out semi-automatically with input from the user or automatically by the content management module.

At block 162, upon the creation or editing of a unit of content by a creator, if the unit of content contains images, the contained image(s) can be included in a list of association candidates. At block 164, if the unit of content does not have any images, the content management module generates a list of keywords based on the content of the unit of content. The keywords may be generated according to various known techniques. For example, the text of the unit of content may be analyzed to retrieve terms occurring abnormally frequently, or that are unusual. Alternately, the user can select and suggest the keyword(s) to the system. At block 166, the content management module suggests at least one image reflective of the article content by adding the at least one image to a list of association candidates for the unit of content. The suggested image is preferably obtained from the content in the unit of content, such a picture present in an article; however, images may further be retrieved from the image bank 400 and added to the list of association candidates for the specific unit of content. In the latter case, the keywords may be compared to metadata (such as keywords or search tags) associated with the images in the image bank in order to retrieve relevant images. At block 168, the user may further be offered the option to upload a specific image or a plurality of images for the unit of content to be added as image association candidates. At block 170, the user selects at least one image from the list of association candidates to create an image composite. Specifically, the user selects an association candidate to be assigned and saved to the unit of content. At block 172, alternatively, if no image assignment is detected, the system automatically assigns an image or a plurality of images based on the keywords. The association candidates may be ranked based on their relative similarity (such as semantic similarity) to the list of keywords, and at least the most similar association candidate may be assigned to the unit of content. At block 174, subsequently, during navigation of the knowledge repository in the user interface generated by the content management system, or in search results of search functions 180 or 190, each unit of content, may be displayed at least in part by including its assigned image to facilitate navigation or review of search results.

In embodiments, multiple images may be assigned to a single unit of content. Similar units of content may have one or more assigned images in common, but may be easily differentiated by a user if at least one of the assigned images for each unit of content differs.

In embodiments, if a previously created unit of content has been assigned an image, the assigned image may be changed based on the method 160 described above. The assigned image may be changed, for example, manually or when the unit of content is edited.

As an example of use of the method 160, a reporter can assign an image or a plurality of images to an article to accelerate subsequent content retrieval by selecting an image candidate from the article, or uploading an image from a storage device (such as a digital camera), or by relying on the automatic assignment of an image to the article based on its content from an image bank such as Google Images.

In some embodiments, the content management module imports images from the image bank, and processes the images according to a classification function in order to automatically generate metadata for each of the images in the image bank. The content management module may thereafter compare generated keywords for a unit of content to the generated metadata in order to select an association candidate.

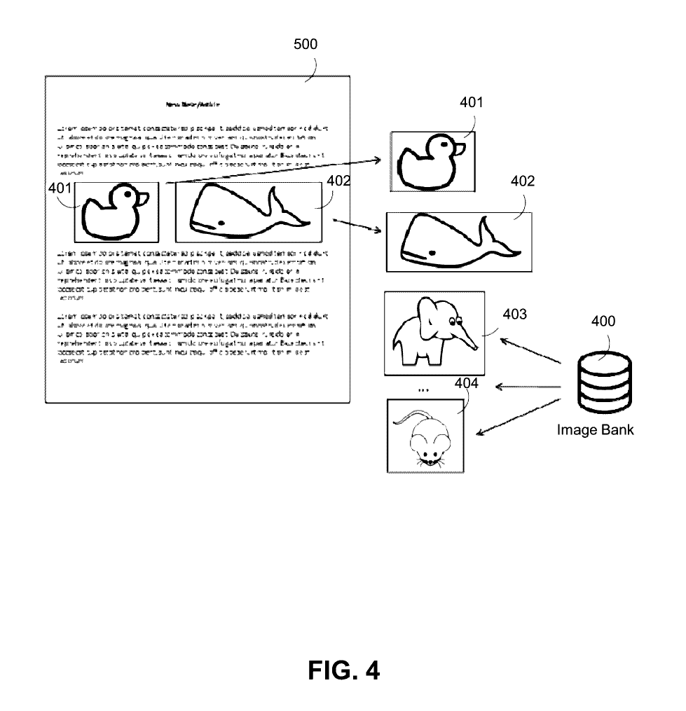

FIG. 4 shows a schematic diagram for the method of content image association 160, which may be carried out semi-automatically with input from the user or automatically by the content management module based on the content of an article 500, such as its title and a list of keywords from its text. The content management module may suggest a plurality of image association candidates 401-404 obtained from the article 500 and/or from an image bank 400 based on user input and/or a list of keywords. The user or the system can select from the image association candidates 401-404 and assign one image 401 or more than one image 401-404 to the metadata of the article 500 to be subsequently retrieved during user navigation of the repository or by a search query, pursuant to methods 180, 190. The selected images 401-404 can be placed in some part of the article or the assigned images 401-404 may merely be displayed as a visual cue during navigation or in search results to help the user locate specific information.

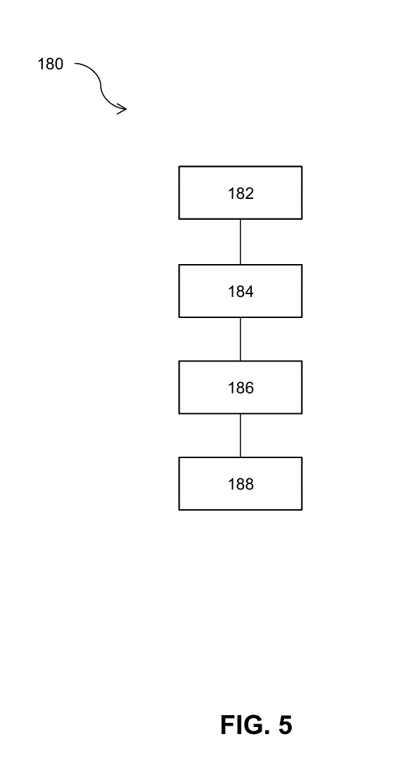

Referring now to FIG. 5, an example search function 180 is shown. The search function is executed to locate information within the knowledge repository. The search function 180 comprises: at block 182, accessing the knowledge repository by a user utilizing a search query executed to retrieve relevant results; at block 184, executing a search by the content management module with relevant keywords (or phrase queries) provided by the user, selected by the user for locating relevant content; and, at block 186, presenting relevant results (e.g. notes or articles) based on the keywords with any assigned image(s) to provide visual association cues. At block 188, the user may then manually filter the search results based on the images assigned to each unit of content in the search results in order to quickly locate relevant information.

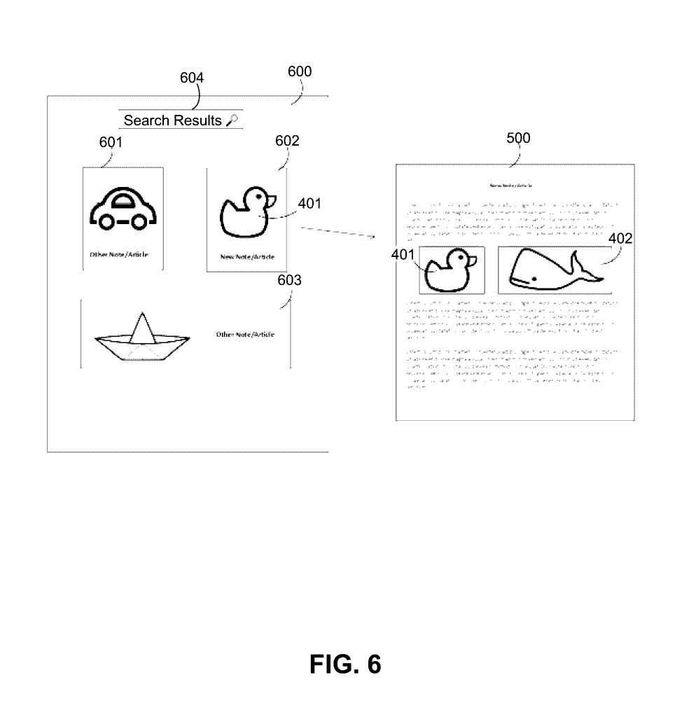

As shown diagrammatically in FIG. 6, a user can perform a search by providing keywords in a search box 604 of the user interface provided by the content management module in order to locate an article. Search results 600 are illustrated which comprise units of content with respective content excerpts (such as a short description), along with respective associated images 601-603. The user can locate specific information (such as an article) based on the visual cues (image 401 assigned to the article 500) in the search result page 600.

In embodiments, in addition to displaying the assigned images in search results, the assigned images may also be displayed while the user navigates the system—i.e. while the user directly accesses the private knowledge repository and navigates therein utilizing the user interface provided by the content management module. For example, if the user navigates to a user interface screen displaying units of content, each unit of content may have its assigned images displayed.

In addition to executing a search of the knowledge repository 118 according to the search function 180 wherein an associated image is shown along with search results, in some embodiments the content management system may further limit search results based on a user's network according to a network constrained search function 190.

As described above, in private knowledge repositories, stored information may merely have relevance to the user that added the information to the repository, or may have relevance to particular communities of users within an organization (e.g. group, business unit, departments, enterprise, project, etc.). For example, stored information may be of relevance to training for a particular role in a project team, or to administrative policies for a particular business unit. The network constrained search function 190 may help to ensure that a user is shown relevant results based on the user's working group in an organization (referred to as a “work grouping”), and based on the user's direct connections in a social network hosted by the content management module for the knowledge repository. This reduces the scope of search results to a narrower result set comprising results that are most likely of relevance to the user. Supplemented by the visual cues realized through full or nearly full image association, the system speeds up manual search result set review.

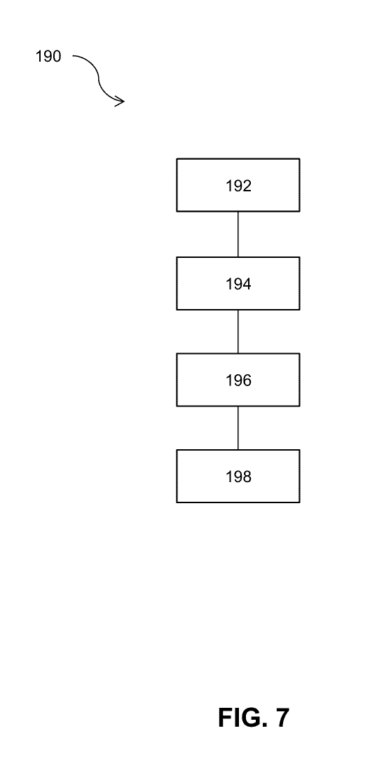

Referring now to FIG. 7, shown therein is a network constrained search function 190 for filtering search results based on the relationship of a user with content creators. The network constrained search function 190 comprises: at block 192, accessing the knowledge repository by a user utilizing a search query executed to retrieve relevant results; at block 194, executing a search by the content management module with relevant keywords (or phrase queries) provided by the user, selected by the user for locating relevant content; and, at block 196, presenting relevant results based on the keywords and according to a network-constrained search of the knowledge repository, and optionally displaying relevant units of content along with any assigned images. At block 198, the user may then manually filter the search results based on the images assigned to each unit of content in the search results in order to quickly locate relevant information.

Various embodiments of operations carried out the by the content management module at block 196 are contemplated. Various embodiments of operations carried out at block 196 relate to embodiments wherein the content management module hosts a social network accessible to the users of the system of content management 100.

Accordingly, in embodiments the content management module hosts a social network, accessible to the users of the system 100 through the user interface of the content management module. The social network is most relevant to the sharing of enterprise knowledge in that it specifies two types of social relationships, a first being social connections which are initiated by users, and a second being organization connections based upon working groups (teams, business units, etc.) in the organization. Whereas the users are permitted to establish and maintain their own desired social connections, working groups are semi-static in that they reflect hierarchical and/or other enterprise-relevant groupings.

The user interface may display, in various user interface views navigable by the users, units of content created by each of the users for the knowledge repository (according to the method 150), in addition to an identifier for each user stored in the user information, as well as optionally any images assigned to the units of content. The users of the system may ‘connect’ with one another on the social network either: unilaterally, wherein a given user may select another user for establishing a connection; or reciprocally, wherein the act of connecting may require one user to request another user to connect, and the second user may be required to accept the request for the connection to be established. The implementation of unilateral connection may be preferred in enterprise knowledge management as it would be generally desirable from the enterprises' perspective to permit users to have access to the content and creators each user believes to be most relevant to him or herself.

In such embodiments, the user information in the knowledge repository may comprise information relating to the user's participation in the social network, such as the user's social connections. Further, the user information may comprise work groupings for each of the users of the system. The work groupings may establish immediate working colleagues of each user. The work groupings may be based on an organizations, divisions, departments, and small groupings. For example, a given work grouping may include all employees reporting to a particular manager. Optionally, the work groupings may be manually configurable by the users or may be configured by system administrators. In further embodiments, the work groupings may be automatically generated based on organization charts of an organization, or based on a clustering analysis of the social network. The clustering analysis may include automatically clustering users into work groupings based on, for example, centrality, cohesion, density, and betweeness of possible clusters.

In various embodiments, at block 196, the search results may be constrained based on the user's work grouping, the user's connections, and the respective work groupings of the user's connections. Particularly, at block 196, when the content management module executes a search prompted by a user, the content management module may only return results generated by one or more of: (i) creators within the user's work grouping, (ii) the user's social connections, and (iii) users within the work groupings of the user's social connections.

For example, assuming that a first user A was organized into a work grouping with users B, C, and D, and that the user had connected with E. The E user may be connected with a number of other users X, Y, Z, and is organized into a work grouping, which does not include users X,Y,Z. When the first user A conducts a search according to the method 190, the search results may be limited to content created by users A, B, C, D (i.e. the user A's work grouping), user E, and users in E's work grouping. The search excludes the users X, Y, Z that user E has connected with from the search results. This supposes that the user A is ambivalent to the information contained in units of content created by user E's connections, but is interested in reviewing information generated by users in user E's work grouping.

In some embodiments, instead of merely relying on local connections data, data may be ingested from a third-party social network 126 in order to supplement information accessible by the content management module 102 to establish a more comprehensive matrix of connections for the network constrained search function 190. Accessing the data of each user from third-party social networks may require receiving an access token to receive the users' data. To this end, standards such as OAuth may be utilized.

Accordingly, in various embodiments, in addition to displaying associated images along with search results, search results can further be constrained based on relationships of creators with users.

Referring now to FIGS. 8 to 12, shown therein are possible user interface screens for the content management system.

FIG. 8 shows a possible home screen for a user in the user interface provided by the content management system, wherein a plurality of units of content 801 posted by the user may be shown, and any lower-level content (such as comments) may further be shown. Each of the content items may be displayed with an assigned image 802.

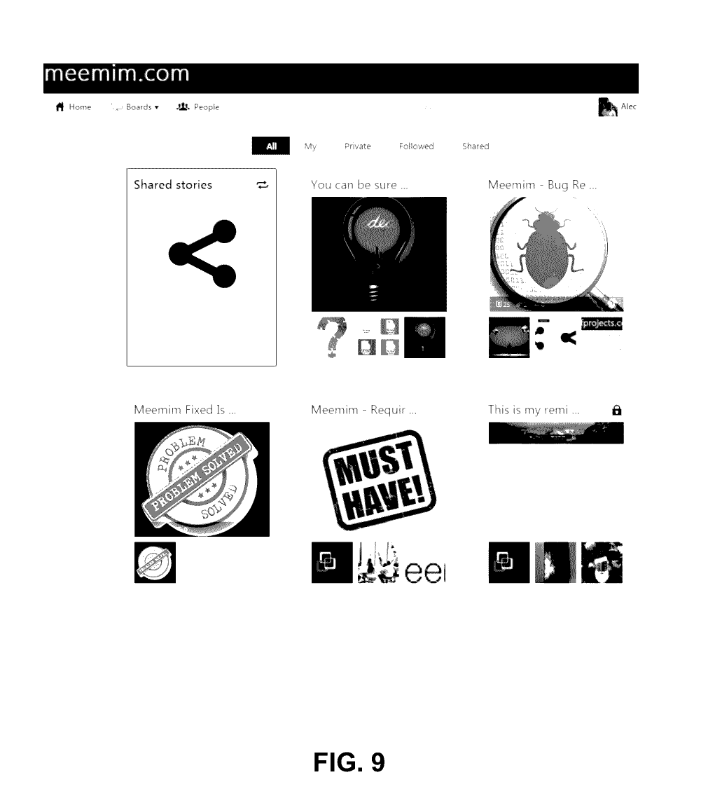

FIG. 9 shows a possible aggregative view of units of content (referred to as a “board”) selected by a user in the user interface. Each of the boards may comprise a plurality of units of content.

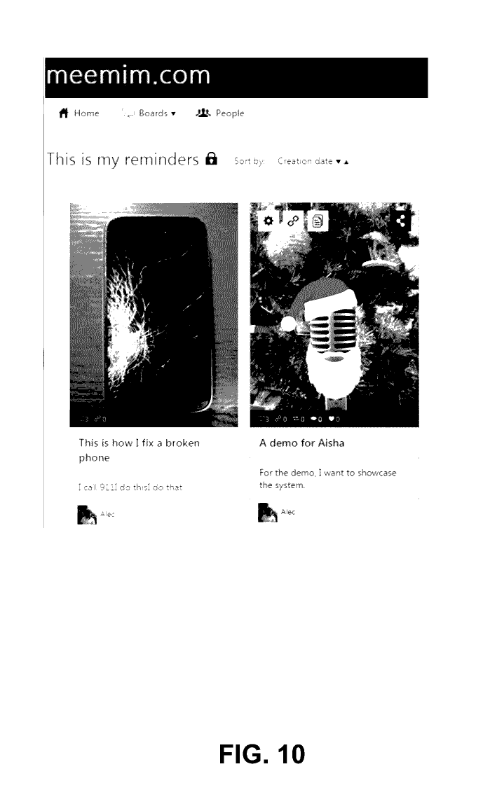

FIG. 10 shows one of the possible boards, comprising two units of content, and assigned images.

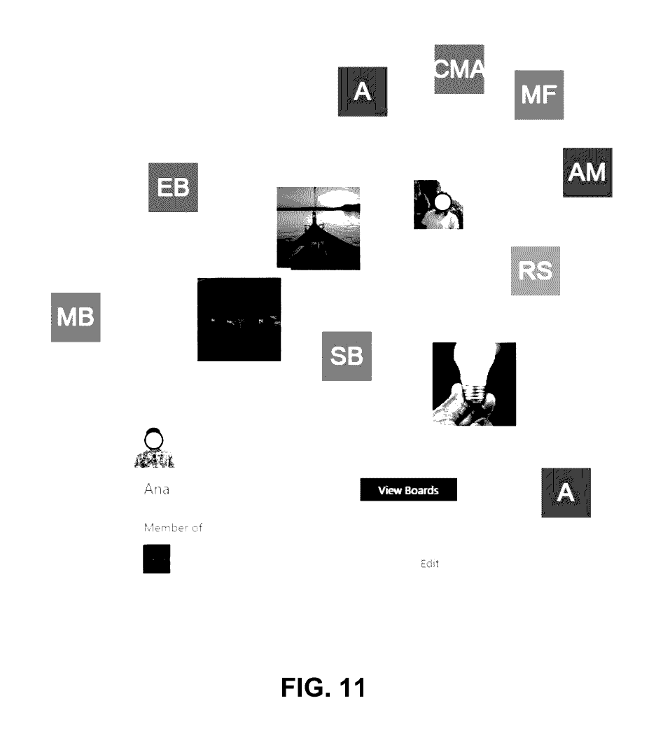

FIG. 11 shows a possible graphical representation of a user's social network, illustrating users as nodes and connections as edges.

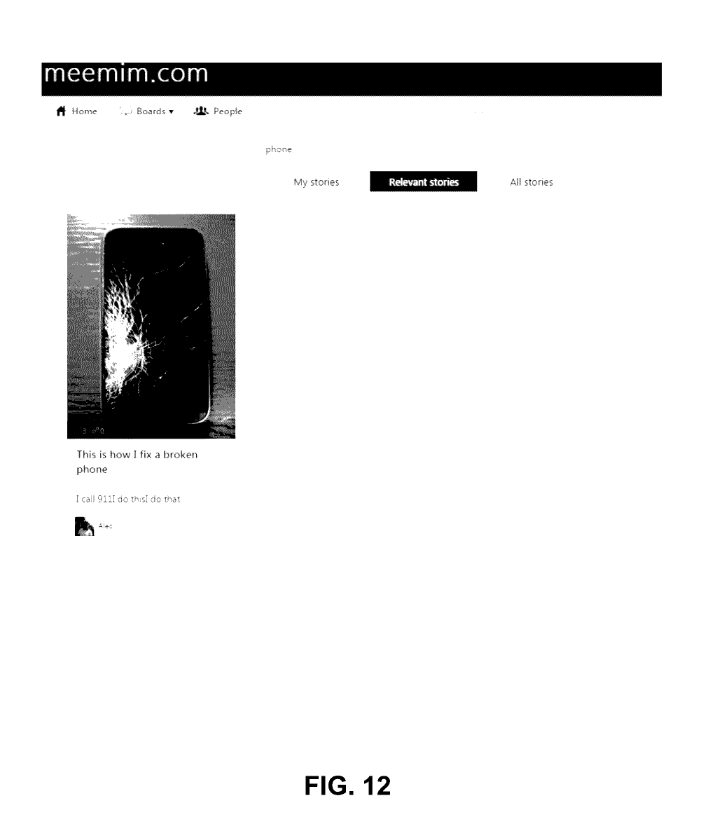

FIG. 12 shows a possible search result 600.

Although the foregoing has been described with reference to certain specific embodiments, various modifications thereto will be apparent to those skilled in the art without departing from the spirit and scope of the invention as outlined in the appended claims

1. An enterprise knowledge management system comprising:
a. an electronic content repository configured to store a plurality of units of content; and
b. a content management module communicatively linked to the electronic content repository configured to:
i. receive from a creator a unit of content;
ii. store the unit of content to the electronic content repository;
iii. process the unit of content to assign an image to the unit of content;
iv. receive a search query from a user; and
v. display the assigned image in response to the search upon the search relating to the content.

2. An enterprise knowledge management system comprising:
a. an electronic content repository configured to store a plurality of units of content; and
b. a content management module communicatively linked to the electronic content repository configured to:
i. establish an enterprise social network having a plurality of users, each user being configured to have a plurality of direct social connections to other users and being assigned to one or more work grouping;
ii. receive from a plurality of creator users a plurality of units of content, each unit of content being associated with its respective creator user;
iii. store the plurality of units of content to the electronic content repository;
iv. receive a search query from a searching user;
v. search the electronic content repository according to the search query to generate search results comprising units of content associated with creator users that are directly socially connected to the searching user, within the same work grouping of the searching user, and within the same work grouping as users directly socially connected to the searching user.

3. An image association content storage and retrieval system, wherein said system comprises:
a. a content creation process to create a piece of information with an image candidate;
b. a content editing process to edit a piece of information and add an image candidate;
c. said image candidate is processed with an image association process;
d. said piece of information with said image candidate saved in a knowledge repository;
e. said knowledge repository contains a plurality of pieces of information accompanied by a plurality of said image candidates;
f. said piece of information being retrieved from said knowledge repository by a user using a search engine;
g. said system displays a set of search results comprising of a plurality of pieces of information being accompanied with a plurality of image associations;
h. said set of search results being filtered by said user; and
whereby said user relies on visual association cues in said set of search results to find a relevant piece of information in accelerated content retrieval.

4. The image association content storage and retrieval system of claim 1, wherein said image association process comprises steps of:
a. selecting an association image candidate from said piece of information;
b. selecting an association image candidate from an image bank based on a list of keywords; and
c. nominating and assigning an image composite from said association image candidates to said piece of information.

5. The image association content storage and retrieval system of claim 4, wherein said image bank being selected from the groups consisting of a digital camera, a storage device, and an online source.

6. The image association content storage and retrieval system of claim 4, wherein said image composite being selected based on semantic relationships between said list of keywords and said association image candidates.

7. The image association content storage and retrieval system of claim 3, wherein said knowledge repository being selected from the groups consisting of:
a. a volatile memory;
b. a non-volatile memory;
c. a removable digital memory; and
d. an on-line storage system.

8. The image association content storage and retrieval system of claim 3, wherein said set of search results comprises of a plurality of short descriptions of said pieces of information accompanied by a plurality of said image candidates based on a keyword-search on said search engine.

9. The image association content storage and retrieval system of claim 8, wherein said keyword-search being selected from the groups consisting of a standard keyword and a phrase query.

10. The image association content storage and retrieval system of claim 3, wherein said set of search results provides a parallel visual process to accelerate performance of the search process.

11. The image association content storage and retrieval system of claim 3, wherein said image candidate being a plurality of said image candidates.

12. The image association content storage and retrieval system of claim 3, wherein a plurality of said image candidates being assigned to said piece of information.

13. The image association content storage and retrieval system of claim 3, wherein said piece of information being selected from the groups consisting of a news article, research results, a report, an academic analysis, an analysis and a debate.

14. An image association content storage and retrieval method, wherein said method comprising steps of:
a. creating process of a piece of information with an image candidate;
b. editing process of a piece of information with an image candidate;
c. processing said image candidate with an image association process;
d. saving said piece of information with said image candidate in a knowledge repository;
e. retrieving said piece of information from said knowledge repository by a user using a search engine;
f. displaying a set of search results comprising of a plurality of pieces of information being accompanied with a plurality of image associations;
g. filtering said set of search results by said user; and
whereby said user relies on visual association cues in said set of search results to find a relevant piece of information in an accelerated content retrieval method.

15. The image association content storage and retrieval method of claim 14, wherein said image association process comprises steps of:
a. selecting an association image candidate from said piece of information;
b. selecting an association image candidate from an image bank based on a list of keywords; and
c. nominating and assigning an image composite from said association image candidates to said piece of information.

16. The image association content storage and retrieval method of claim 15, wherein said image bank being selected from the groups consisting of a digital camera, a storage device, and an online source.

17. The image association content storage and retrieval method of claim 15, wherein said image composite being selected based on a semantic relationship between said list of keywords and said association image candidates.

18. The image association content storage and retrieval method of claim 14, wherein said knowledge repository being selected from the groups consisting of:
a. a volatile memory;
b. a non-volatile memory;
c. a removable digital memory; and
d. an on-line storage system.

19. The image association content storage and retrieval method of claim 14, wherein said set of search results comprises of a plurality of short descriptions of said pieces of information accompanied by a plurality of said image candidates based on a keyword-search on said search engine.

20. The image association content storage and retrieval method of claim 19, wherein said keyword-search being selected from the groups consisting of a standard keyword and a phrase query.

21. The image association content storage and retrieval method of claim 14, wherein a plurality of said image candidates being assigned to said piece of information.

22. The image association content storage and retrieval method of claim 14, wherein said piece of information being selected from the groups consisting of a news, a research, a research results, a report, an academic analysis, an analysis and a debate.
